(19) United States
(12) Patent Application Publication
(10) Pub. No.: US 2013/0089389 A1
(43) Pub. Date: Apr. 11, 2013

(54) FASTENER WITH LOW PROFILE HEAD AND WASHER

(71) Applicant: Illinois Tool Works Inc., Glenview, IL (US)

(72) Inventors: Yongping Gong, Wilmette, IL (US); Mark D. Latz, Chicago, IL (US); Brian Keith Van Dyke, Palatine, IL (US)

(73) Assignee: ILLINOIS TOOL WORKS INC., Glenview, IL (US)

(21) Appl. No.: 13/629,565

(22) Filed: Sep. 27, 2012

Related U.S. Application Data
(60) Provisional application No. 61/545,518, filed on Oct. 10, 2011.

(51) Int. Cl. F16B 23/00

(52) U.S. Cl. 411/371.2

(57) ABSTRACT

A fastener assembly is provided with a fastener and a washer. The fastener includes a low profile head coupled to a shaft, wherein the low profile head has an underside and an outwardly facing side opposite from the underside. The outwardly facing side has a tapered portion surrounding a central flat portion having a drive recess. The underside has a washer recess disposed about the shaft and configured to hold or accomodate a washer.

### CROSS REFERENCE TO RELATED APPLICATION

This application claims priority from and the benefit of U.S. Provisional Application Ser. No. 61/545,518, entitled “FASTENER WITH LOW PROFILE HEAD AND WASHER”, filed Oct. 10, 2011, which is hereby incorporated by reference in its entirety.

### BACKGROUND

Fasteners, such as screws, may be used to secure objects, such as wood, metal, or plastic objects, to each other. Fasteners are used in a wide variety of construction applications. For example, it is known to use fasteners to secure roof and side paneling to building structures. In such applications, environmental or weather conditions can result in water or moisture leaking through at the locations of the fasteners, potentially damaging the underlying building structures.

Certain fasteners are used in hidden locations, whereas other screws may be used in more visible locations, such on the exterior of a building. Certain known fasteners used to secure paneling to buildings have large protrusive heads, which can be aesthetically unpleasing.

There is therefore an existing need for fasteners and fastener assemblies that provide a water-tight seal and have an aesthetically pleasing appearance.

### SUMMARY

Various embodiments of the present disclosure provide a fastener assembly with a fastener and a washer (e.g., a sealing washer). The fastener includes a low profile head coupled to a shaft, wherein at least a portion of the shaft is threaded. The low profile head has an underside and an outwardly facing side opposite from the underside. The outwardly facing side has a tapered portion (e.g., a conical surface) surrounding a central flat portion having a drive recess (e.g., to receive a tip of a driving tool). The underside has a washer recess disposed about the threaded shaft. The washer is disposed in the washer recess about the shaft.

In this manner, the fastener assembly of present disclosure provides a water tight seal, provides a better appearance when the fastener assembly is in place, eliminates the “battleship” look attributed to protrusive fasteners, provides a solution for applications requiring panel lapping, reduces installation time, and reduces leakage even when driven at an angle, and reduces maintenance associated with leakage.

These and other features, aspects, and advantages of the present invention will become better understood when the following detailed description is read with reference to the accompanying drawings in which like characters represent like parts throughout the drawings.

### DRAWINGS

FIG. 1 is a perspective view of an example fastener having a low profile head and a washer in accordance with an embodiment of the present disclosure;

FIG. 2 is a side view of the example fastener illustrated in FIG. 1;

FIG. 3 is a cross-sectional side view of the example fastener illustrated in FIG. 1;

FIG. 4 is a top view of the example fastener illustrated in FIG. 1;

FIG. 5 is a perspective view of an example fastener having a low profile head and a washer in accordance with another embodiment of the present disclosure;

FIG. 6 is a side view of the example fastener illustrated in FIG. 5; and

FIG. 7 is a cross-sectional side view of the example fastener illustrated in FIG. 5.

### DETAILED DESCRIPTION

One or more embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

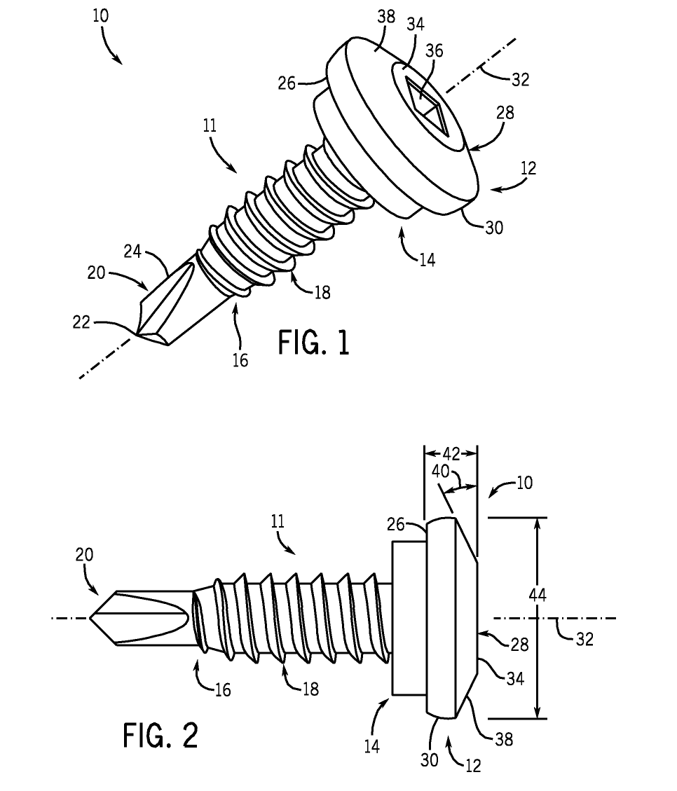

Referring now to FIGS. 1, 2, 3, and 4, an example fastener assembly 10 according to an embodiment of the present disclosure is shown. The fastener assembly 10 includes a fastener 11 (e.g., a screw) having a low profile head 12 and a shaft 16, and a washer 14 (e.g., an annular washer) disposed about the shaft 16 adjacent to the low profile head 12. The shaft 16 extends away from the low profile head 12. The shaft 16 includes a threaded portion 18 and a self-tapping tip portion 20. The threaded portion 18 may include any of a variety of threads, such as an anti-back out thread or any other suitable thread. For example, the threads may include serrations to help resist unthreading of the fastener 11. The self-tapping tip portion 20 may include a sharp tip 22 and a cutting edge 24. In certain embodiments, the tip portion 20 may be a Teks/1 point, a Teks/2 point, a Teks/3 point, a Teks/4 point, a Teks/5 point, or any other tip configuration. In certain embodiments, the fastener 11 also may include a protective coating, such as a weather resistant coating, a wear resistant coating, a moisture resistant coating, a chemical resistant coating, or any combination thereof. For example, the fastener 11 may include at least one of a zinc coating, a P3 powder coating, or a color coating (e.g., paint to match a target object). By further example, the fastener 11 may include any suitable polymer coating, metal oxide coating (e.g., aluminum-oxide coating), etc.

The washer 14 is located or retained between the shaft 16 and the low profile head 12. In certain embodiments, the washer 14 may be directly bonded to an underside 26 of the low profile head 12, while in other embodiments the washer 14 is not bonded to the underside 26 of the low profile head 12. In either configuration, the washer 14 may be held within a washer recess formed in the underside 26 (e.g., a recessed surface) as discussed in further detail below. For example, the underside 26 may have a generally annular recess to receive the washer 14.

The washer 14, in certain embodiments, may be a sealing washer (e.g., a rubber washer or o-ring). It should be appreciated, however, that the washer 14 may be any suitable washer which facilitates sealing of a bore, thereby helping to prevent damage (e.g., due to water leakage) to any underlying building structure. The washer 14 may be comprised of any suitable compressible material, including modified or unmodified bitumen, tar, neoprene, fluoroelastomer, silicone, natural rubber, or any suitable synthetic rubber, for example. Furthermore, the washer 14 may include multiple layers of different materials, such as concentric ring-shaped layers, axially stacked layers, or any combination thereof. For example, the layers of the washer 14 may vary in stiffness or resiliency, such as a rigid layer surrounded by two resilient layers. By further example, the layers of the washer 14 may include layers with different properties, such as one layer with greater resiliency or compressibility, one layer with greater chemical resistance, one layer with greater corrosion resistance, one layer with greater biological resistance (e.g., resistant to mold growth), or any combination thereof. The configuration of the fastener and integral washer of the disclosed fastener assembly 10 (as described in more detail below) provides a weather proof seal at the fastened connection, even if the fastener is driven into the substrate at an angle that is not exactly perpendicular to the substrate. For example, the fastener assembly 10 can provide a sealed connection when driven at a 90, 85, 80, 75, 70, 65, 60, 55, 50, 45, 40, 35, 30, 25, 20, or 15 degree angle relative to the substrate.

In the illustrated example embodiment, the low profile head 12 has an outwardly facing side 28 opposite from the underside 26, and a lateral side 30 extending about a longitudinal axis 32 of the fastener 11 between the outwardly facing side 28 and the underside 26. In the illustrated embodiment, the outwardly facing side 28 includes a central flat portion 34 having a drive recess 36, and an outer tapered portion 38 extending between the central flat portion 34 and the lateral wall 30. In various alternative embodiments, the drive recess 36 may be a square-shaped recess, a slotted recess, a cross-shaped recess, a pentagon-shaped recess, or any other suitable recess. The tapered portion 38 may be angled (e.g., a constant angle of approximately 1 to 50 degrees) relative to both the central flat portion 34 and the underside 26. In certain embodiments, the tapered portion 38 may have a single angle or multiple angles (e.g., 2, 3, 4, 5, or more) between the flat portion 34 and the lateral side 30. In either case, each angle of the tapered portion 38 is constant over some distance. In other words, in such embodiments, the angle of the tapered portion 38 does not continuously vary (i.e., not a curve) between the flat portion 34 and the lateral side 30. For example, the tapered portion 38 may be described as a conical portion (e.g., a conical exterior surface) having a constant angle between the flat portion 34 and the lateral side 30. In some embodiments, the tapered portion 38 may have a single conical exterior surface with a single constant angle, or the tapered portion 38 may have a plurality of conical exterior surfaces each having a different constant angle. The lateral side 30 may be described as an annular side, which may be cylindrical, conical, or slightly curved as shown in FIG. 1. The underside 26 may include a washer recess configured to receive or hold the washer 14.

FIG. 2 is a side view of an embodiment of the fastener assembly 10 illustrated in FIG. 1, further illustrating the low profile head 12. As illustrated in FIG. 2, the tapered portion 38 of the low profile head 12 has an angle 40 relative to the flat portion 34, wherein the angle 40 is generally between approximately 1 to 60 degrees. For example, in certain embodiments, the angle 40 may be approximately 5 to 50, 10 to 45, 15 to 40, 20 to 35, or 25 to 30 degrees. By further example, the angle 40 may be less than or equal to approximately 10, 15, 20, 25, 30, 35, 40, or 45 degrees. By further example, the angle 40 may be less than or equal to approximately 20, 21, 22, 23, 24, 25, 26, 27, 28, 29, 30, 31, 32, 33, 34, or 35 degrees. By further example, the angle 40 may be less than or equal to approximately 25 or 30 degrees. However, the foregoing angles 40 of the tapered portion 38 are intended to be non-limiting examples. In other embodiments, the tapered portion 38 may have other angles 40 suitable for a particular application.

Furthermore, the illustrated head 12 may have a height 42 and a width or diameter 44. In certain embodiments, the height 42 may be less than approximately 1, 2, 3, 4, 5, 6, or 7 millimeters. For example, the height 42 may be approximately 0.5 to 7, 1 to 6, or 2 to 5 millimeters. However, the height 42 may vary across different implementations of the fastener 11. Likewise, the width or diameter 44 may vary across different implementations, but may range between approximately 5 to 30 millimeters. For example, the width or diameter 44 may range between approximately 5 to 20, 7.5 to 17.5, 10 to 15, 11 to 14, or 12 to 13 millimeters. As appreciated, the foregoing height 42 and width 44 dimensions of the low profile head 12 are intended to be non-limiting examples. In other embodiments, the height 42 and width 44 of the head 12 may have other dimensions suitable for a particular application. In certain embodiments, a height/width ratio of the height 42 to the width or diameter 44 may range between approximately 0.1 to 0.4, 0.2 to 0.375, 0.25 to 0.35, or 0.275 to 0.325. For example, the height/width ratio may be less than or equal to approximately 0.35, 0.325, 0.3, 0.275, 0.25, 0.225, 0.2, 0.175, 0.15, 0.125, or 0.1. However, the foregoing height/width ratios of the low profile head 12 are intended to be non-limiting examples. In other embodiments, the head 12 may have other height/width ratios suitable for a particular application.

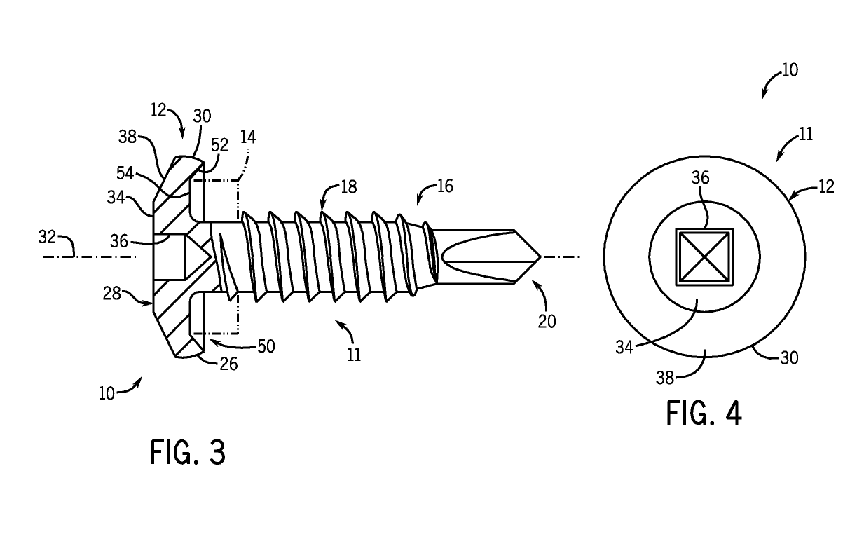

FIG. 3 is a cross-sectional side view of an embodiment of the threaded fastener 11 illustrated in FIG. 1, further illustrating the underside 26 and the drive recess 36 of the low profile head 12. As illustrated, the drive recess 36 extends axially into the head 12 from the flat portion 34, and may have any of a variety of shapes as described above. The underside 26 includes a washer recess 50 extending axially into the head 12 away from the threaded shaft 16. In the illustrated embodiment, the washer recess 50 includes a tapered portion 52 surrounding a central flat portion 54 (e.g., a disc-shaped flat portion around the threaded shaft 16). For example, the tapered portion 52 may be described as a conical surface that extends inwardly toward a flat surface of the central flat portion 54. In certain embodiments, the tapered portion 52 may have an angle of approximately 10 to 60 relative to the flat portion 54. For example, the angle between the portions 52 and 54 may be approximately 40 to 50 degrees, or about 45 degrees. However, the foregoing angles are intended to be non-limiting examples. In other embodiments, the fastener 11 may have other angles between the portions 52 and 54 as appropriate for a particular application. The tapered portion 52 may help to retain and compress the washer 14 (shown in dashed lines) between the head 12 and substrate into which the fastener is driven. For example, the tapered portion 52 may bias the washer 14 in both axial and radial directions relative to the axis 32, thereby helping to maintain a more positive seal between the washer 14 and both the head 12 and the substrate.

FIG. 4 is a top view of an embodiment of the fastener 11 illustrated in FIG. 1, further illustrating the drive recess 36 within the central flat portion 34. In the illustrated embodiment, the drive recess 36 is a square shaped drive recess 36 configured to mate with a square-headed tool. However, in other embodiments, the drive recess 36 may include a slotted recess, a cross-shaped recess, a pentagon-shaped recess, or any other suitable recess.

Referring now to FIGS. 5, 6, and 7, an embodiment of a fastener assembly 110 having a fastener 111 (e.g., a screw) having a low profile head 112 and a washer 114 is shown. As illustrated, the fastener 111 has a shaft 116 extending away from the low profile head 112, wherein the shaft 116 includes a threaded portion 118 and a self-tapping tip portion 120. The threaded portion 118 may include a variety of threads, such as anti-back out threads. The self-tapping tip portion 120 may include a sharp tip 122 and a cutting edge 124. In certain embodiments, the tip portion 120 may be a Teks/1 point, a Teks/2 point, a Teks/3 point, a Teks/4 point, a Teks/5 point, or any other tip configuration.

In the illustrated embodiment, the low profile head 112 has an outwardly facing side 128 opposite from the underside 126, and a lateral side 130 extending about a longitudinal axis 132 of the fastener 111 between the outwardly facing side 128 and the underside 126. In the illustrated embodiment, the outwardly facing side 128 includes a central flat portion 134 having a drive recess 136, and an outer curved portion 138 extending between the central flat portion 134 and the lateral wall 130. In certain embodiments, the drive recess 136 may be a square-shaped recess, a slotted recess, a cross-shaped recess, a pentagon-shaped recess, or any other suitable recess. The curved portion 138 may gradually curve from the flat portion 134 to the lateral side 130. For example, the curved portion 138 may be described as a convex portion (e.g., curved annular shape) having a variable angle (e.g., continuously increasing or decreasing angle) between the flat portion 134 and the lateral side 130. The lateral side 130 may be described as an annular side, which may be cylindrical, conical, or slightly curved as shown in FIG. 5. The underside 126 includes a washer recess configured to receive or hold the washer 114.

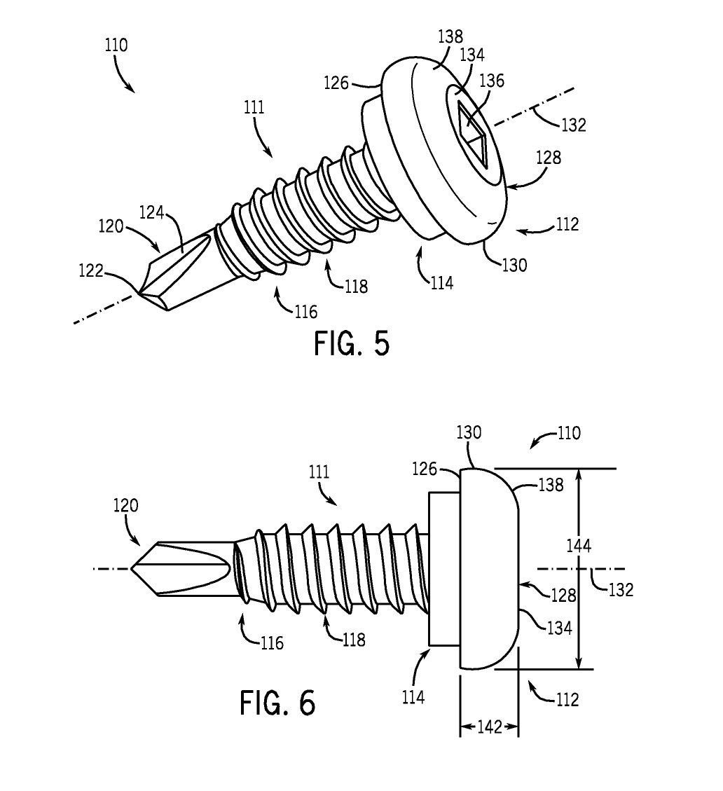

As shown in FIG. 6, the curved portion 138 of the low profile head 112 gradually curves from the flat portion 134 to the lateral wall 130 over an angular span of approximately 90 degrees. Furthermore, the illustrated head 112 may have a height 142 and a width or diameter 144. In certain embodiments, the height 142 may be less than approximately 1, 2, 3, 4, 5, 6, or 7 millimeters. For example, the height 142 may be approximately 0.5 to 7, 1 to 6, or 2 to 5 millimeters. However, the height 142 may vary across different implementations of the fastener 11. Likewise, the width or diameter 144 may vary across different implementations, but may range between approximately 5 to 30 millimeters. For example, the width or diameter 144 may range between approximately 5 to 20, 7.5 to 17.5, 10 to 15, 11 to 14, or 12 to 13 millimeters. As appreciated, the foregoing height 142 and width 144 dimensions of the low profile head 112 are intended to be non-limiting examples. In other embodiments, the height 142 and width 144 of the head 112 may have other dimensions suitable for a particular application. In certain embodiments, a height/width ratio of the height 142 to the width or diameter 144 may range between approximately 0.1 to 0.4, 0.2 to 0.375, 0.25 to 0.35, or 0.275 to 0.325. For example, the height/width ratio may be less than or equal to approximately 0.35, 0.325, 0.3, 0.275, 0.25, 0.225, 0.2, 0.175, 0.15, 0.125, or 0.1. However, the foregoing height/width ratios of the low profile head 112 are intended to be non-limiting examples. In other embodiments, the head 112 may have other height/width ratios suitable for a particular application.

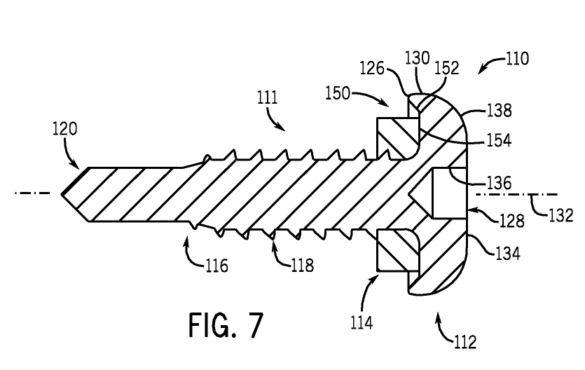

As shown in FIG. 7, the drive recess 136 extends axially into the head 112 from the flat portion 134, and may have a variety of shapes as described above. As discussed above, the underside 126 includes a washer recess 150. The washer recess 150 extends axially into the head 112 away from the shaft 116. In the illustrated embodiment, the washer recess 150 includes a tapered portion 152 surrounding a central flat portion 154 (e.g., a disc-shaped flat portion around the shaft 116). For example, the tapered portion 152 may be described as a conical surface that extends inwardly toward a flat surface of the central flat portion 154. In certain embodiments, the tapered portion 152 may have an angle of approximately 10 to 60 relative to the flat portion 154. For example, the angle between the portions 152 and 154 may be approximately 40 to 50 degrees, or about 45 degrees. However, the foregoing angles are intended to be non-limiting examples. In other embodiments, the fastener 111 may have other angles between the portions 152 and 154 as appropriate for a particular application. The tapered portion 152 may help to retain and compress the washer 114 between the head 112 and a substrate. For example, the tapered portion 152 may bias the washer 114 in both axial and radial directions relative to the axis 132, thereby helping to maintain a more positive seal between the washer 114 and both the head 112 and the substrate.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fastener assembly, comprising:
a fastener comprising a low profile head coupled to a shaft, wherein the low profile head comprises an underside and an outwardly facing side opposite from the underside, wherein the outwardly facing side comprises a tapered portion surrounding a central portion having a drive recess, and the underside comprises a washer recess disposed about the shaft; and
a washer disposed in the washer recess about the shaft.

2. The fastener assembly of claim 1, wherein the tapered portion comprises a conical surface.

3. The fastener assembly of claim 1, wherein an angle of the tapered portion relative to the central flat portion is approximately 10 to 45 degrees.

4. The fastener assembly of claim 1, wherein an angle of the tapered portion relative to the central flat portion is approximately 20 to 35 degrees.

5. The fastener assembly of claim 1, wherein an angle of the tapered portion relative to the central flat portion is approximately 25 degrees.

6. The fastener assembly of claim 1, wherein an angle of the tapered portion relative to the central flat portion is approximately 30 degrees.

7. The fastener assembly of claim 1, wherein the central portion includes a flat surface.

8. The fastener assembly of claim 1, wherein the shaft includes a threaded portion.

9. The fastener assembly of claim 1, wherein the washer comprises modified or unmodified bitumen, tar, neoprene, fluoroelastomer, silicone, or rubber.

10. A fastener, comprising:
a low profile head coupled to a shaft, wherein the low profile head comprises an underside and an outwardly facing side opposite from the underside, wherein the outwardly facing side comprises a tapered portion surrounding a central portion having a drive recess, and the underside comprises a washer recess disposed about the shaft.

11. The fastener of claim 10, further comprising a washer disposed in the washer recess.

12. The fastener of claim 11, wherein the washer is made of a compressible material.

13. The fastener of claim 12, wherein the compressible material comprises modified or unmodified bitumen, tar, neoprene, fluoroelastomer, silicone, or rubber.

14. The fastener of claim 10, wherein the tapered portion comprises a conical surface.

15. The fastener of claim 10, wherein an angle of the tapered portion relative to the central portion is approximately 10 to 45 degrees.

16. A fastener assembly, comprising:
a fastener comprising a head coupled to a shaft, wherein the head comprises an underside and an outwardly facing side opposite from the underside, wherein the outwardly facing side comprises a tapered portion surrounding a central portion having a drive recess, and the underside comprises a washer recess disposed about the shaft; and
a washer disposed in the washer recess about the shaft, wherein the washer is made of a compressible material.

17. The fastener assembly of claim 16, wherein the compressible material comprises modified or unmodified bitumen, tar, neoprene, fluoroelastomer, silicone, or rubber.

18. The fastener assembly of claim 16, wherein the shaft comprises a self-tapping tip portion.

19. The fastener assembly of claim 16, wherein the fastener comprises a protective coating.

20. The fastener assembly of claim 16, wherein an angle of the tapered portion relative to the central portion is approximately 10 to 45 degrees.
